(19) United States
(12) Patent Application Publication
(10) Pub. No.: US 2025/0282313 A1
(43) Pub. Date: Sep. 11, 2025

(54) IN-VEHICLE OBJECT

(71) Applicant: TOYOTA JIDOSHA KABUSHIKI KAISHA, Toyota-shi (JP)

(72) Inventors: Ayumi WATANABE, Toyota-shi (JP); Hidenori UNO, Toyota-shi (JP); Takahisa NAGATA, Toyota-shi (JP)

(73) Assignee: TOYOTA JIDOSHA KABUSHIKI KAISHA, Toyota-shi (JP)

(21) Appl. No.: 19/051,626

(22) Filed: Feb. 12, 2025

(30) Foreign Application Priority Data
Mar. 5, 2024 (JP) 2024-033302

(51) Int. Cl. B60R 16/06

(52) U.S. Cl. CPC B60R 16/06

(57) ABSTRACT

Provided is an in-vehicle object that can reduce the likelihood that a driver feels slightly uncomfortable due to the fact that particulates or gas and the like suspended in a vehicle interior become positively charged. The in-vehicle object comprises a charged object having a surface negatively charged. At least a surface layer of the charged object is made of a fiber aggregate containing a plurality of conductive fibers. Each of the plurality of conductive fibers is a fiber including a conductive material exposed from a resin material, such that the conductive material is negatively charged.

### CROSS REFERENCE TO RELATED APPLICATIONS

The present application claims priority from Japanese patent application JP 2024-033302 filed on Mar. 5, 2024, the entire content of which is hereby incorporated by reference into this application.

### BACKGROUND

### Technical Field

The present disclosure relates to an in-vehicle object.

### Background Art

In JP H09-39131 A, for example, an in-vehicle object for preventing an interior part from being charged is proposed. This in-vehicle object is a surface material for automobile interior in which a covering material is adhesively integrated with the surface of a wadding material made of fiber filaments. The wadding material is mixed with antistatic fibers that exhibit an electrostatic neutralization function by self-discharge. By using such a surface material for the interior part of an automobile such as a door trim, a ceiling, or a seat cover of the automobile, it is possible to prevent the interior part from being charged.

### SUMMARY

However, particulates or gas and the like in a vehicle may become positively charged due to the positive charge generated from an electric component of the vehicle or the like. Even if it is possible to prevent the interior part in the vehicle from being charged by installing the surface material described in JP H09-39131 A, the positive charge of the particulates or gas and the like suspended in the vehicle interior cannot be eliminated. Consequently, the vehicle's interior ambience may cause a driver to feel slightly uncomfortable and may also cause the driver to feel that the maneuverability of the vehicle has decreased slightly.

The present disclosure has been made in view of the above, and provides an in-vehicle object that can reduce the likelihood that a driver feels slightly uncomfortable due to the fact that particulates or gas and the like suspended in a vehicle interior become positively charged.

In view of the foregoing, the present disclosure is an in-vehicle object to be installed in a vehicle interior. The in-vehicle object comprises a charged object having a surface negatively charged. At least a surface layer of the charged object is made of a fiber aggregate containing a plurality of conductive fibers. Each of the plurality of conductive fibers is a fiber including a conductive material exposed from a resin material, such that the conductive material is negatively charged.

According to the present disclosure, the surface of the charged object constituting the in-vehicle object is negatively charged. As a result, even if particulates or gas and the like suspended in the vehicle interior become positively charged, the positive charge of the particulates or gas and the like can be eliminated by the negative charge on the surface of the charged object. In particular, in the present disclosure, at least a surface layer of the charged object is made of a fiber aggregate containing a plurality of conductive fibers, and a conductive material of the conductive fiber is negatively charged. As a result, since the negatively charged surface of the charged object is formed three-dimensionally by the fiber aggregate, the positive charge of the particulates or gas and the like suspended in the vehicle interior can be more effectively eliminated. In this way, it is possible to reduce the likelihood that a driver feels slightly uncomfortable due to the fact that the particulates or gas and the like suspended in the vehicle interior become positively charged.

### BRIEF DESCRIPTION OF THE DRAWINGS

FIG. 1 is a schematic view for describing a charged object constituting an in-vehicle object in an embodiment of the present disclosure;

FIG. 2 is a cross-sectional view of a surface layer of the charged object shown in FIG. 1;

FIG. 3A is a schematic perspective view of a conductive fiber shown in FIG. 1;

FIG. 3B is a schematic perspective view of another aspect of the conductive fiber shown in FIG. 3A;

FIG. 4A is a schematic perspective view of a mount base constituting the in-vehicle object;

FIG. 4B is a schematic perspective view of the mount base with the charged object placed thereon; and

FIG. 5 is a schematic perspective view for describing the in-vehicle object shown in FIG. 4B when installed in a vehicle interior.

### DETAILED DESCRIPTION

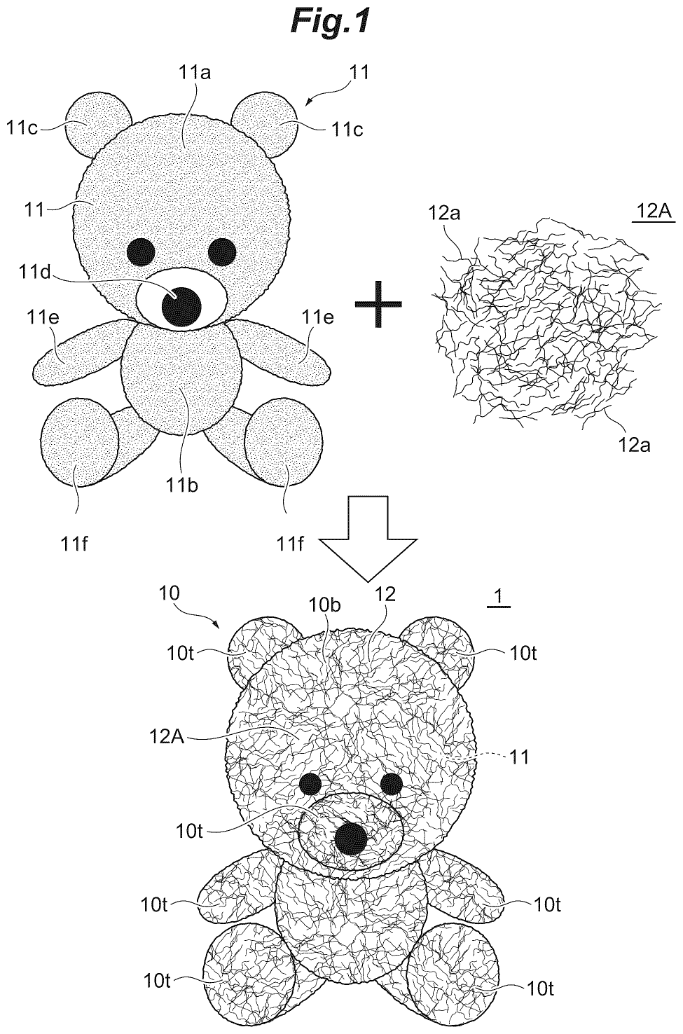

An in-vehicle object 1 according to the present embodiment will be described below referring to FIG. 1 to FIG. 5.

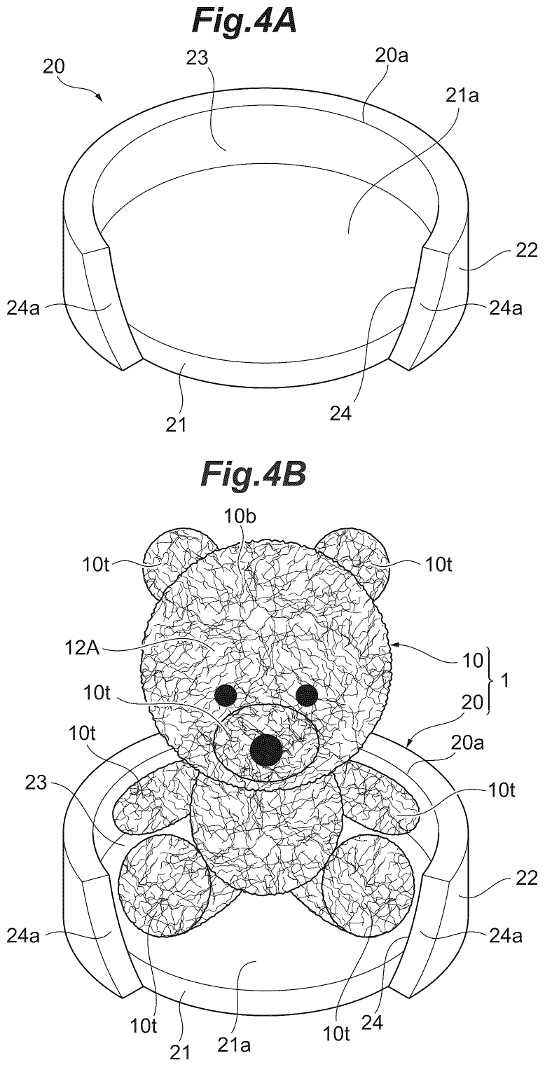

The in-vehicle object 1 according to the present embodiment is installed in a vehicle interior and includes at least a charged object 10. Note that the in-vehicle object 1 may include only the charged object 10 shown in FIG. 1, or may include the charged object 10 and a mount base 20 as shown in FIG. 4B.

As shown in FIG. 1, the charged object 10 is a structure in which a base 11 such as a stuffed toy is covered with a fiber aggregate 12A containing a plurality of conductive fibers 12a. The surface of the charged object 10 is negatively charged by the conductive fibers 12a, which will be described later.

The base 11 is a three-dimensional structure having a plurality of protruding portions. Examples of the three-dimensional structure may include a stuffed toy resembling an animal or character or a doll. In the present embodiment, the base 11 is a stuffed toy bear and has a head portion 11a and a body portion 11b. The base 11 includes a pair of ear portions 11c, 11c protruding from the head portion 11a and a nose portion 11d. Further, the base 11 includes a pair of arm portions 11e, 11e protruding from the body portion 11b, and a pair of leg portions 11f, 11f.

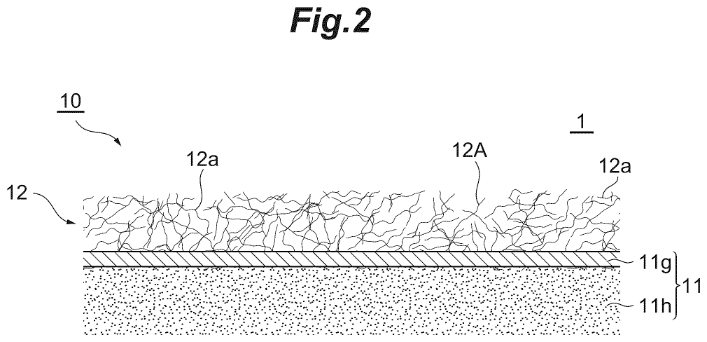

As shown in FIG. 2, the base 11 is filled with a cushioning material 11h such as cotton or wool inside a skin 11g made of a fabric material such as a woven fabric or nonwoven fabric. In the present embodiment, the charged object 10 includes a surface layer 12 which is formed by covering the skin 11g of the base 11 with the fiber aggregate 12A. Thus, at least the surface layer 12 of the charged object 10 is made of the fiber aggregate 12A containing the plurality of conductive fibers 12a, 12a. However, the skin 11g or the like of the base may be made of a fabric material made of the conductive fibers.

Here, portions of the base 11 including the head portion 11a and the body portion 11b covered with the fiber aggregate 12A serve as a main body 10b of the charged object 10. The charged object 10 includes a plurality of projections 10t, 10t protruding from the main body 10b of the charged object 10. The projections 10t serve as the ear portions 11c, the nose portion 11d, the arm portions 11e, and the leg portions 11f of the base 11 covered with the fiber aggregate 12A. In this way, the charged object 10 is a three-dimensional structure having the plurality of projections 10t, 10t.

In the present embodiment, the fiber aggregate 12A is composed of only the plurality of conductive fibers 12a, but may include a natural fiber or a synthetic fiber as long as it can make the surface of the charged object 10 negatively charged, for example. In the fiber aggregate 12A, the plurality of conductive fibers 12a is randomly arranged. The conductive fiber 12a includes a conductive material 14 exposed from a resin material 13, such that the conductive material 14 is negatively charged.

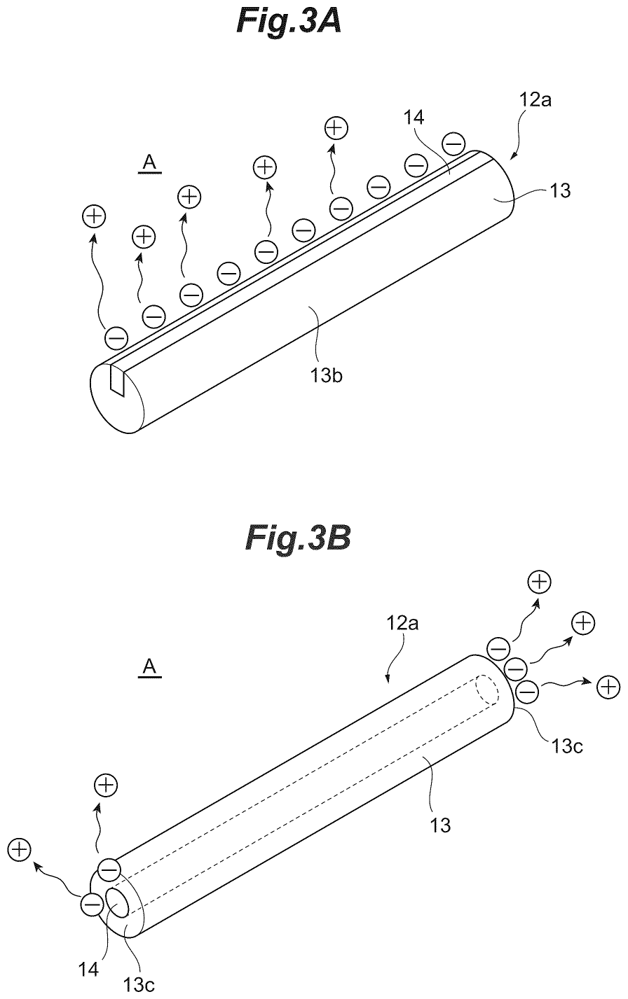

Specifically, as shown in FIG. 3A, the conductive material 14 extends along the longitudinal direction of the conductive fiber 12a. The conductive material 14 is embedded in the resin material 13 so as to be exposed along the longitudinal direction of the conductive fiber 12a from a circumferential surface 13b of the resin material 13 in a filament form. Accordingly, the conductive material 14 exposed from the circumferential surface 13b of the conductive fiber 12a will be negatively charged.

Also, as shown in FIG. 3B, the conductive material 14 extends along the longitudinal direction of the conductive fiber 12a. The conductive material 14 is inserted into the resin material 13 in a wire form along the central axis, and the conductive material 14 is exposed from an end face 13c of the resin material 13. Even in such a case, the conductive material 14 exposed from the end face 13c of the resin material 13 will be negatively charged.

By using the conductive fibers 12a as shown in FIG. 3A and FIG. 3B, it is possible to eliminate the positive charge of the particulates or gas and the like suspended in air A by the electric charge of the negatively charged conductive material 14. The conductive fiber 12a may have a diameter of 3 to 30 μm, for example. The conductive fiber 12a may have a length of 5 mm to 50 mm, for example.

Examples of the resin material 13 may include nylon resins, polyester resins, or acrylic resins. Examples of the conductive material 14 may include carbon or metals. Examples of the carbon may include polyamide containing conductive carbon black and the like, and may be carbon fiber. By selecting such a material, the exposed surface of the conductive material 14 can become negatively charged, and this charge can be maintained. In the present embodiment, in one example, a nylon resin is used for the resin material and carbon is used for the conductive material. Examples of the conductive fiber negatively charged in this manner may include Belltron (registered trademark) available from KB SEIREN, LTD., for example.

In the present embodiment, as shown in FIG. 4A, the in-vehicle object 1 may further comprise a mount base 20 on which the charged object 10 is placed. The mount base 20 is made of foam rubber. The rubber material constituting the mount base 20 is not particularly limited as long as it is an electrically insulating material. Examples of the material may include natural rubber or synthetic rubber. Examples of the synthetic rubber may include urethane rubber, styrene-butadiene rubber, silicone rubber, or fluororubber.

The mount base 20 has a bottom plate 21 on which the charged object 10 is placed and a side wall 22 rising from the periphery of the bottom plate 21. The bottom plate 21 has a circular shape, but is not limited thereto as long as the charged object 10 can be placed thereon. By using such a mount base 20, the lower portion of the charged object 10 can be stably accommodated in a housing space 23 surrounded by the bottom plate 21 and the side wall 22. Further, the side wall 22 of the mount base 20 includes an open portion 24 for opening the housing space 23 so as to provide communication with the housing space 23. This open portion 24 has a pair of inclined surfaces 24a, 24a formed in the side wall 22. With the pair of inclined surfaces 24a, 24a, the open portion 24 is opened to be widened toward the upper side.

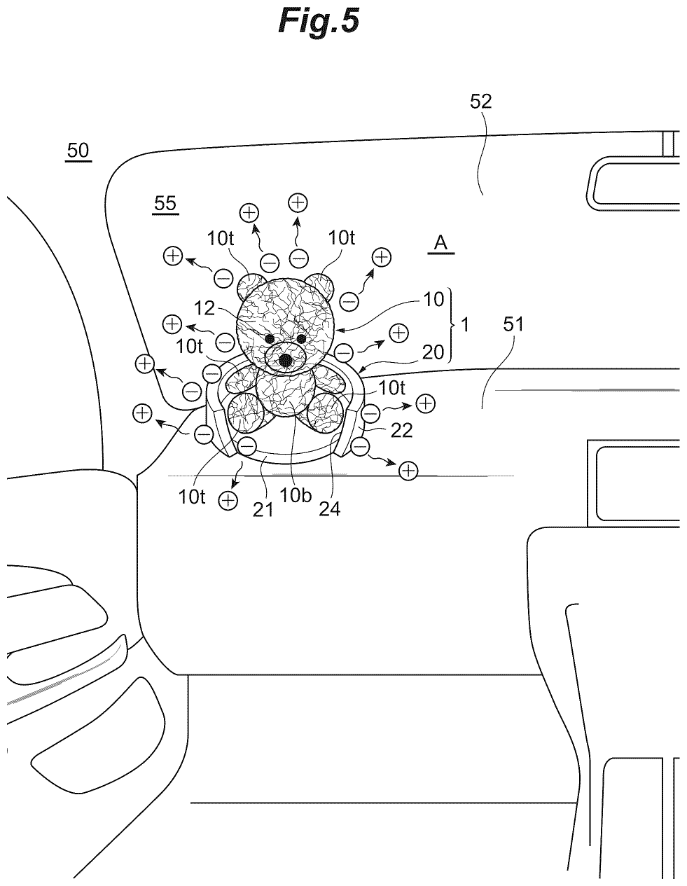

Consequently, as shown in FIG. 4B, the charged object 10 is inserted from an opening 20a of the mount base 20 on its upper side and placed on a placement surface 21a of the bottom plate 21, and in this state, the charged object 10 can be stably accommodated. Further, even when the lower portion of the charged object 10 is accommodated in the housing space 23, the lower portion of the charged object 10 can be exposed from the housing space 23 through the open portion 24. As a result, it is possible to efficiently eliminate the charge of the particulates or gas and the like suspended in the air A of a vehicle interior 55 (see FIG. 5) while stabilizing the attitude of the charged object 10.

According to the present embodiment, as shown in FIG. 5, the in-vehicle object 1 is installed on a dashboard 51 in the vehicle interior 55 of a vehicle 50. In FIG. 5, with the charged object 10 placed on the mount base 20, the in-vehicle object 1 is arranged at a position where the field of view outside the vehicle via a windshield 52 is less likely to be obstructed. Note that as the in-vehicle object 1, only the charged object 10 may be arranged on the dashboard 51.

Here, during the operation of the vehicle 50, the particulates or gas and the like suspended in the air A of the vehicle interior 55 may become positively charged due to the positive charge generated from an electric component (not illustrated) of the vehicle 50 or the like. Even in such a case, the surface of the charged object 10 constituting the in-vehicle object 1 will be negatively charged. As a result, even if the particulates or gas and the like suspended in the vehicle interior 55 become positively charged, the positive charge of the particulates or gas and the like can be eliminated by the negative charge on the surface of the charged object 10.

At least the surface layer 12 of the charged object 10 is made of the fiber aggregate 12A containing the plurality of conductive fibers 12a, and the conductive material 14 of the conductive fibers 12a is negatively charged. As a result, since the negatively charged surface of the charged object 10 is formed three-dimensionally by the fiber aggregate 12A, the positive charge of the particulates or gas and the like suspended in the vehicle interior 55 can be more effectively eliminated. In particular, such an effect is more pronounced because, in the fiber aggregate 12A, the plurality of conductive fibers 12a is randomly arranged.

In particular, since the charged object 10 is a three-dimensional structure having the plurality of projections 10t, the positive charge of the particulates or gas and the like suspended in the vehicle interior 55 can be eliminated three-dimensionally. Further, since the mount base 20 on which the charged object 10 is placed is made of the rubber material of the foam rubber, the charged object 10 and the dashboard 51 are electrically insulated from each other by the mount base 20. In particular, the insulating properties can be further enhanced by foaming the rubber. Consequently, even when the surface of the dashboard 51, for example, becomes positively charged, this positive charge can be prevented from moving to the charged object 10, and thus a static elimination effect by the charged object 10 can be ensured. In this way, it is possible to reduce the likelihood that the driver feels slightly uncomfortable due to the fact that the particulates or gas and the like suspended in the vehicle interior become positively charged.

### Confirmation Test 1

As the conductive fiber shown in FIG. 3B, Belltron (registered trademark) available from KB SEIREN, LTD. was prepared, and a test piece was prepared in which 8% by mass of the conductive fiber was mixed in a felt made of PET. In the conductive fiber, the resin material was made of nylon. The size of the test piece was 45 mm×45 mm. The test piece was pre-dried at 70° C. for 1 hour and then left for 24 hours under standard conditions. For this test piece, the decay rate after 120 seconds was measured according to JIS L 1094 A method (half-life measurement method). As a result, the initial electrostatic voltage of the test piece was −1.61 kV, and the electrostatic voltage after 120 seconds after the application of a voltage of 10 kV was −0.11 kV. From this result, it was found that the test piece containing the conductive fiber was negatively charged. Further, since the electrostatic voltage after 120 seconds was lower than the initial electrostatic voltage, it was also confirmed that the test piece containing the conductive fiber had a static elimination effect.

### Confirmation Test 2

Test was conducted by drivers in the following conditions 1 to 3. The charged object 10 (see FIG. 1) having a width of 50 mm and a height of 70 mm was prepared. For the conductive fiber, the charged object 10 using the conductive fiber 12a of FIG. 3A was prepared and the charged object 10 using the conductive fiber 12a of FIG. 3B was prepared. In condition 1, the in-vehicle object 1 in which the charged object 10 shown in FIG. 4B was installed on the mount base 20 was arranged on the dashboard 51. In condition 2, only the charged object 10 shown in FIG. 1 was used as the in-vehicle object 1, and this was arranged on the dashboard 51. In condition 3, no in-vehicle object was arranged.

In these conditions 1 to 3, each of the plurality of drivers got on the vehicle and operated the vehicle. As a result of the sensory evaluations by the plurality of drivers, the following evaluations A to F were obtained from the drivers in condition 1 and condition 2 compared with condition 3.

Evaluation A: Steering play during lane change is small.

Evaluation B: Steering is stable at any of the low-speed and the high-speed.

Evaluation C: Car sickness is reduced.

Evaluation D: Fatigue is reduced during long-distance operation.

Evaluation E: Operation becomes smooth.

Evaluation F: Vehicle acceleration including the vehicle start time becomes smooth.

From the above result, it is considered that in condition 1 and condition 2, even if the particulates or gas and the like suspended in the vehicle interior are positively charged, the charged object 10 using the conductive fiber 12a of FIG. 3A and the charged object 10 using the conductive fiber 12a of FIG. 3B allow elimination (neutralization) of the charge. As a result, it is considered that it is possible to reduce the likelihood that the driver feels slightly uncomfortable due to the positively charged particulates or gas and the like. Furthermore, it is found that these evaluations A to F in condition 1 are higher than those in condition 2. From the above result, it is considered that since the mount base 20 on which the charged object 10 is placed is made of foam rubber, the charged object 10 and the dashboard 51 are electrically insulated from each other. Consequently, it is considered that it is possible to stably ensure the state where the surface of the charged object 10 is negatively charged.

Although the embodiment of the present disclosure has been described in detail above, the present disclosure is not limited to the foregoing embodiment, and various design changes can be made without departing from the spirit of the present disclosure described in the claims.

### DESCRIPTION OF SYMBOLS

1 In-vehicle object
10 Charged object
12 Surface layer
12a Conductive fiber
12A Fiber aggregate
13 Resin material
14 Conductive material
20 Mount base

What is claimed is:

1. An in-vehicle object to be installed in a vehicle interior, the in-vehicle object comprising a charged object having a surface negatively charged,
wherein at least a surface layer of the charged object is made of a fiber aggregate containing a plurality of conductive fibers, and
wherein each of the plurality of conductive fibers is a fiber including a conductive material exposed from a resin material, such that the conductive material is negatively charged.

2. The in-vehicle object according to claim 1, wherein the charged object is a three-dimensional structure having a plurality of projections.

3. The in-vehicle object according to claim 1, further comprising a mount base on which the charged object is placed, wherein the mount base is made of foam rubber.

4. The in-vehicle object according to claim 1, wherein in the fiber aggregate, the plurality of conductive fibers is randomly arranged.
